(19) United States
(12) Patent Application Publication
(10) Pub. No.: US 2003/0211309 A1
(43) Pub. Date: Nov. 13, 2003

(54) Polypropylene films

(75) Inventors: Vittoriano DiLuzio, Morristown, TN (US); Paul Alder, Quebec (CA); Michael T. Heffelfinger, Alpharetta, GA (US)

Correspondence Address: HINKLE & O'BRADOVICH, LLC, 395 SCENIC HIGHWAY, LAWERENCEVILLE, GA, 30045, US

(73) Assignee: Vifan USA, Inc.

(21) Appl. No.: 10/141,031

(22) Filed: May 8, 2002

(51) Int. Cl. B32B 3/26

(52) U.S. Cl. 428/317.9; 428/318.6; 428/319.3; 428/543

(57) ABSTRACT

Polypropylene films and methods for making the films having white opaque characteristics are disclosed. The films typically incorporate polymer blending to improve microcavitation, increased opacity, increased optical density and lower light transmission for a white opaque film with CaCO₃ loading at and above 40% by weight. A combination of polypropylene resins of specified density, crystallinity and ratio relationships have been identified with TiO₂.

### BACKGROUND OF THE INVENITON

I. Field of the Invention

The present invention relates generally to the field of polypropylene and more particularly to polypropylene films having a voided core layer producing opaque characteristics.

II. Description of the Related Art

White opaque polypropylene films have a variety of uses and are produced in a variety of ways. The white opaque films are typically made from a master batch that includes organic and inorganic fillers. The master batch is made into a film that is biaxially oriented. The process typically creates films having the opaque characteristics. The films can have a variety of further characteristics such as a heat sealable layer, a printable layer and a breathable layer to name a few. However, often times there are limitations in the filler that can be used in the master batch which also can limit the ultimate film characteristics. Such limitation typically include the ratio of the fillers used in the master batch, and ultimately the film.

### SUMMARY OF THE INVENTION

In general, the invention features polypropylene films having white opaque characteristics.

The embodiments have incorporated polymer blending to improve microcavitation, increased opacity, increased optical density and lower light transmission for a white opaque film with CaCO₃ loading at and above 40% by weight. A combination of polypropylene resins of specified density, crystallinity and ratio relationships have been identified in addition with TiO₂.

In one aspect, the invention features a resin combination having a thermoplastic polymer matrix having dispersed therein as distinct phase, a multiplicity of small solid particles of filler, the resin combination in opaque biaxially oriented polymeric film form and the same oriented film structure having on at least one surface a void-free thermoplastic skin layer.

In another aspect, the invention features a process for preparing a biaxially oriented opaque film including providing the above-described resin combination and biaxially orienting the film to an extent sufficient to opacify the film. The process also provides for the opaque film having a void-free thermoplastic skin layer on at least one of the surface of the film.

In general, in one aspect, the invention features a biaxially oriented polypropylene film, including a core film layer having a polymer matrix including a propylene polymer, the polymer matrix being about 30-90% by weight and a particulate filler disposed within the matrix, the filler being about 50-70% by weight

In one implementation, the filler comprises calcium carbonate having particle size of about 0.7 to 3 microns.

In another implementation, the calcium carbonate is present at and above 40% by weight.

In another implementation, the filler comprises titanium dioxide at about 0-5% by weight.

In another implementation, the filler has a particle size of about 0.7 to 3 microns.

In another aspect, the invention features a biaxially oriented white opaque film including a film layer, the film layer including about 30-90% by weight of a polymer matrix including a low crystallinity propylene polymer; and about 50-70% by weight of a particulate filler disposed within the matrix.

In one implementation, the polymer matrix comprises at least 50% of the low crystallinity propylene polymer, by weight of the matrix.

In another implementation, the polymer matrix comprises at least 70% of the low crystallinity propylene polymer, by weight of the matrix.

In another implementation, the polymer matrix comprises at least 90% of the low crystallinity propylene polymer, by weight of the matrix.

In another implementation, the low crystallinity propylene polymer comprises a polypropylene homopolymer or blend thereof having not more than about 30% crystallinity.

In another implementation, the low crystallinity propylene polymer comprises a propylene-ethylene copolymer having up to 6% by weight ethylene.

In another implementation, the low crystallinity propylene polymer comprises a co polymer of propylene with up to 20% by weight of an alpha-olefin comonomer having 4 to 8 carbon atoms.

In still another implementation, the alpha-olefin comonomer comprises butene.

In yet another implementation, the alpha-olefin comonomer constitutes about 10-20% by weight of the propylene copolymer.

In another implementation, the low crystallinity propylene polymer comprises a propylene-ethylene copolymer and a propylene-butene copolymer.

In another implementation, the two copolymers are present in a weight ratio of about 9:1 to about 1:9.

In another implementation, the two copolymers are present in a weight ratio of about 7:3 to about 3:7.

In another implementation, the polymer matrixfurther comprises at least one additional polymer.

In another implementation, the at least one additional polymer constitutes not more than 50% by weight of the polymer matrix.

In another implementation, the at least one additional polymer is selected from the group consisting of polyethylene homopolymers and copolymers, polypropylene homopolymers and copolymers, elastomers, and combinations thereof.

In another implementation, the at least one additional polymer comprises very low density polyethylene.

In another implementation, the particulate filler comprises an inorganic filler.

In another implementation, the inorganic filler comprises calcium carbonate.

In another implementation, the particulate filler comprises an organic filler.

In another implementation the film is stretch oriented at least biaxially to about 3×6 times the original area.

In another implementation, the film is stretched to 18 times the original area.

In another implementation, the film is stretch oriented at least biaxially to about 4×7 or 28 times the original area.

In another implementation, the film is stretched 28 times the original area.

In another implementation, the film is stretch oriented at least biaxially to about 5×8 the original area.

In another implementation, the film is stretched to 40 times the original area.

In another aspect, the invention features a multilayered polypropylene film, including a voided core layer having a first surface and a second surface including polypropylene and particulate voiding agent, a first non-voided outer layer including polypropylene adhered to the first surface of the core layer and a second non-voided outer layer including polypropylene adhered to the second surface of the core layer.

In one implementation, the voided core layer includes about 40% and above by weight of calcium carbonate.

In another implementation, the voided core layer includes about 0-5% by weight of titanium dioxide.

In another implementation, the first non-voided outer layer is flame treated.

In another implementation, the second non-voided outer layer is corona discharge treated.

One advantage of the invention is that it includes improved microcavitation and increase opacity.

Another advantage is that the combination has increase optical density and lower light transmission using filler above 40% by weight using a combination of polypropylene resins of specified density and ratio relationships along with titanium dioxide (TiO₂).

Other objects, advantages and capabilities of the invention will become apparent from the following description taken in conjunction with the accompanying drawings showing the preferred embodiment of the invention.

### DETAILED DESCRIPTION OF THE INVENTION

High opacity and optical density as well as low light transmission is achieved in polypropylene films by using a combination of polypropylene resins of specified density and ratio relationships and inorganic particulate fillers and alternatively organic fillers. The inorganic fillers typically include CaCO₃, TiO₂ and combinations thereof. The CaCO₃ is typically in the range of 40-70% by weight. The TiO₂ is typically in the range of 0-5% by weight. The fillers described above are used as voiding agents in polypropylene film structures. The amount of the CaCO₃ voiding agent used is typically at and above 40% by weight. The TiO₂ voiding agent used in combination with the CaCO₃ is typically 0-5% by weight. In other embodiments, other whitening agents can be used along with or in replacement of the above mentioned agents. Such additional agents can include lithopone.

In one embodiment the film can include about 30-90% by weight of a polymer matrix including a low crystallinity propylene polymer and about 50-70% by weight of a particulate filler disposed within the matrix. The low crystallinity propylene polymer can include several different types of polymers, such as homopolymers, copolymers and terpolymers. In an implementation, the polymer matrix includes at least 50%, 70% or 90% of the low crystallinity propylene polymer, by weight of the matrix. The low crystallinity propylene polymer can include a polypropylene homopolymer or blend thereof having not more than about 30% crystallinity. In another implementation, the low crystallinity propylene polymer comprises a propylene-ethylene copolymer having up to 6% by weight ethylene. In another implementation, the low crystallinity propylene polymer comprises a copolymer of propylene with up to 20% by weight of an alpha-olefin comonomer having 4 to 8 carbon atoms. The alpha-olefin comonomer can include butene. In another implementation, the alpha-olefin can constitute about 10-20% by weight of the propylene copolymer. In another implementation, the low crystallinity propylene polymer can include a propylene-ethylene copolymer and a propylene-butene copolymer, wherein the two copolymers are present in a weight ratio of about 9:1 to about 1:9. Alternatively, the two copolymers are present in a weight ratio of about 7:3 to about 3:7.

In another embodiment, the polymer matrix used in the film can include at least one additional polymer. Typically, the additional polymer constitutes not more than 50% by weight of the polymer matrix. The additional polymer can include polyethylene homopolymers and copolymers, polypropylene homopolymers and copolymers, elastomers, and combinations thereof. In an implementation, the additional polymer comprises very low density polyethylene.

A typical polypropylene film structure includes a voided core layer having one or more types of filler particulate voiding agents as described above. The film further includes two outer layers including non-voided polypropylene, as described above. The core layer is typically about 24 microns and the outer layers are typically about 2.0 microns. The outer layers are typically treated by flame or corona discharge treatment. The outer layers typically do not include voiding agents so as to retain gloss.

### Film Preparation

The general method of forming the opaque oriented film is typically accomplished by slot extruding a film of the resin composition (matrix plus Filler) and thereafter sequentially biaxially orienting the film. In one implementation, the film can be stretch oriented at least biaxially to about 3×6 or 18 times the original area. In another implementation, the film can be stretch oriented at least biaxially to about 4×7 or 28 times the original area. In another implementation, the film can be stretch oriented at least biaxially to about 5×8 OR 40 times the original area.

During the orientation, a strata of voids is formed in the matrix polymer. Since the CaCO₃ particles are incompatible with the matrix material, during machine direction orientation each particle tends to create a streamlined void. During subsequent transverse orientation, the transverse dimension of this void is correspondingly increased. During these steps, the film typically turns a bright white pearlescent opaque color. In some instances, in order to avoid the formation of an irregular surface as a result of the spheres and the cavitated condition of the film, a coextruded surface layer can be formed on one or both surfaces of the cavitated film. This coextruded film can be transparent or pigmented and of the same or different material as the matrix resin. The different resin may be chosen for particular characteristics, for example, heat sealability, printability, machinability and the like. When employing a surface or skin layer or layers, the core thickness can typically be from about 30 to about 95% of the overall structure. Conversely, the combined skin thickness typically can be about 5 to about 70% of the overall film thickness. When desired or necessary the skin layers can be sufficiently thick so that the outer surfaces thereof do not manifest any irregularities or surface projections of the core material.

Alternately a biaxially oriented microcavitated film including an amorphous polymer and at or about 50% by weight filler, wherein the amorphous polymer includes a copolymer of ethylene and an alpha-olefin and has a density less than 0.89 g/cm3. The film can also have a first and second side that typically allow the addition of sealable polymers.

### EXAMPLES

The following examples illustrate a typical composition of the films. The core layer typically includes the following:

Polymers:

These examples include the family of isotactic polypropylenes, ethylene modified copolymers, and syndiotactic polypropylene. The example can also include polypropylene random copolymers and multi-purpose thermoplastic olefin resins having a high softness and low modulus.

CaCO3 (25-50%)

Generally, the example can include commercial calcium carbonates 0.85-1.1% treated with particle sizes ranging from 0.7 micron to 2.0 micron to 3.0 micron. Typical top cuts range from 8 to 10 to 12 micron.

TiO2 (0-5%)

The examples typically include commercial grade titanium dioxide.

The following is an example of a film structure. The film includes a micro-voided core with a skin cover on both sides of the core. There can be two formulations. Both formulations use TiO₂ and CaCO₃in the core to attain the opacity of the film. In the first formulation, the masterbatch includes 10% TiO₂ from one compound (PF61V) and 55% TiO₂ from another compound (P8555LM). The masterbatch further includes 60% CaCO₃ from the PF61V. The film percentage of the first formulation includes 76.5% polypropylene from approved homopolymers, 15% of the PF61V compound, 7% of the P8555LM compound and 1.5% Apera 2532X. The final TiO₂ percentage in the film is 1.5% from the PF61V and 3.85% from the P8555LM for a total of 5.35%. The final CaCO₃ percentage is 9%, entirely from the PF61V.

In the first formulation, one skin layer (flame) is 96% KF6190+4% ABPP05 (Random copolymer 4%, Sy45 5%). The second skin layer (corona) is 96% Asyl 5C37F (italie)(PEB Ter, 1000Sy45, Mineral Oil)+4% ABPP05.

In the second formulation, the masterbatch includes 10% TiO₂ from one compound (PF61V) and 55% TiO₂ from another compound (P8555LM). The masterbatch further includes 60% CaCO₃ from PF61V. The film percentage of the first formulation includes 80.5% polypropylene from approved homopolymers, 13% of the PF61V compound, 5% of the P8555LM compound and 1.5% Apera 2532X. The final TiO₂ percentage in the film is 1.3% from the PF61V and 2.75% from the P8555LM for a total of 4.05%. The final CaCO₃ percentage is 7.8%, entirely from the PF61V.

In the second formulation, the first skin layer (flame) is 95% Adsyl 5C37F+4% ABPP05+1% P8555LM. The second skin layer (corona) is 95% KF6190H+4% ABPP05+1% PF61V.

The typical core thickness of both formulations is about 24 microns. The typical skin layers are 2.0 microns.

Test Results
The following table summarizes typical test results:

| | | Factor 1 | | Factor 3 | | Ratio | DSC | | DSC | | DSC | | Response |
|---|---|---|---|---|---|---|---|---|---|---|---|---|---|
| | | A CaCO3 | Factor 2 | C:TiTO2 | | Hard to | deg C | | deg C | | deg C | | 9 |
| Standridge | | Particle | B:CaCO3 | Loading | Total | Soft | Peak | deg | Peak | deg | Peak | deg | Melt |
| Code | Run | mirrons | Loading | DuPont | Inerts | % | Two | F | Two | F | Three | F | Flow |
| 01SAM08132 | 9 | 0.7 Omya. 95T UFT | 25 | 5 | 30 | P1/P2 = 58 | 122.4 | 252.4 | 130.9 | 267.7 | 141.4 | 288.5 | 5.7 |
| 01SAM08129 | 6 | 0.7 | 40 | 5 | 45 | p3/p2 = 57 | 122.3 | 352.1 | 146.2 | 295.1 | 159.2 | 318.6 | 3.8 |
| 01SAM08131 | 8 | 0.7 | 50 | 0 | 50 | P1/P2 = 67 | 120.2 | 248.3 | | | 140.0 | 284.0 | 4.8 |
| 01SAM08128 | 5 | 0.7 | 50 | 5 | 55 | P3/P2 = 41 | 146.4 | 295.5 | 157.6 | 315.7 | 163.2 | 325.8 | 3.6 |
| 01SAM08125 | 2 | 1 FilmLink 400 | 40 | 5 | 45 | P1/P2 = 57 | 123.3 | 253.9 | 132.2 | 270.0 | 142.1 | 287.8 | 6.1 |
| 01SAM08127 | 4 | 1 | 50 | 0 | 50 | P1/P2 = 67 | 120.4 | 248.7 | | | 141.4 | 286.5 | 4.8 |
| 01SAM08124 | 1 | 1 | 50 | 5 | 55 | P1/P2 = 41 | 122.7 | 252.8 | 129.3 | 264.8 | 140.8 | 285.5 | 4.2 |
| 01SAM08126 | 3 | 2 Omya 727 | 50 | 0 | 50 | P1/P2 = 35 | 128.6 | 263.4 | 142.0 | 287.6 | 161.2 | 322.2 | 5.3 |
| 01SAM08134 | 11 | 2 | 40 | 5 | 45 | P4/P5 = 57 | 115.3 | 239.5 | 123.2 | 253.8 | 139.7 | 283.4 | 3.1 |
| 01SAM08135 | 12 | 2 | 50 | 5 | 55 | P4/P5 = 41 | 111.8 | 233.3 | 123.0 | 253.4 | 139.6 | 283.3 | 2.8 |
| 01SAM00944 | 13 | 3 Kotamrts | 50 | 0 | 50 | P3/P2 = 35 | | | 141.6 | 286.9 | 158.4 | 313.5 | 4.1 |
| 01SAM08133 | 10 | 3 | 40 | 5 | 45 | P1/P2 = 57 | 122.3 | 252.1 | 132.8 | 271.1 | 141.0 | 285.8 | 5.5 |
| 01SAM08130 | 7 | 3 | 50 | 0 | 50 | P1/P2 = 35 | 127.0 | 260.6 | | | 140.8 | 285.4 | 5.0 |

P1 = Polymer D6D82
P2 = Polymer Z104S
P3 = Polymer ATO 98-01
P4 = Polymer ATO 8573
P5 = Polymer ATO 96-30

Therefore, the foregoing is considered as illustrative only of the principles of the invention. Further, various modifications may be made of the invention without departing from the scope thereof and it is desired, therefore, that only such limitations shall be placed thereon as are imposed by the prior art and which are set forth in the appended claims.

What is claimed is:

1. A biaxially oriented polypropylene film, comprising:
a core film layer having a polymer matrix including a propylene polymer, the polymer matrix being about 30-90% by weight; and
a particulate filler disposed within the matrix, the filler being about 50-70% by weight.

2. The film as claimed in claim 1, wherein the filler comprises calcium carbonate having particle size of about 0.7 to 3 microns.

3. The film as claimed in claim 2, wherein the calcium carbonate is present at and above 40% by weight.

4. The film as claimed in claim 1, wherein the filler comprises titanium dioxide at about 0-5% by weight.

5. The film as claimed in claim 4, wherein the filler has a particle size of about 0.7 to 3 microns.

6. A biaxially oriented white opaque film including a film layer, the film layer comprising about 30-90% by weight of a polymer matrix including a low crystallinity propylene polymer; and about 50-70% by weight of a particulate filler disposed within the matrix.

7. The film as claimed in claim 6, wherein the polymer matrix comprises at least 50% of the low crystallinity propylene polymer, by weight of the matrix.

8. The film of claim 6, wherein the polymer matrix comprises at least 70% of the low crystallinity propylene polymer, by weight of the matrix.

9. The film as claimed in claim 6, wherein the polymer matrix comprises at least 90% of the low crystal linity propylene polymer, by weight of the matrix.

10. The film of claim 6, wherein the low crystallinity propylene polymer comprises a polypropylene homopolymer or blend thereof having not more than about 30% crystallinity.

11. The film as claimed in claim 6, wherein the low crystallinity propylene polymer comprises a propylene-ethylene copolymer having up to 6% by weight ethylene.

12. The film as claimed in claim 6, wherein the low crystallinity propylene polymer comprises a copolymer of propylene with up to 20% by weight of an alpha- olefin comonomer having 4 to 8 carbon atoms.

13. The film as claimed in claim 12, wherein the alpha-olefin comonomer comprises butene.

14. The film as claimed in claim 12, wherein the alpha-olefin comonomer constitutes about 10-20% by weight of the propylene copolymer.

15. The film as claimed in claim 6, wherein the low crystallinity propylene polymer comprises a propylene-ethylene copolymer and a propylene-butene copolymer.

16. The film as claimed in claim 15, wherein the two copolymers are present in a weight ratio of about 9:1 to about 1:9.

17. The film as claimed in claim 15, wherein the two copolymers are present in a weight ratio of about 7:3 to about 3:7.

18. The film as claimed in claim 6, wherein the polymer matrix further comprises at least one additional polymer.

19. The film as claimed in claim 18, wherein the at least one additional polymer constitutes not more than 50% by weight of the polymer matrix.

20. The film as claimed in claim 18, wherein the at least one additional polymer is selected from the group consisting of polyethylene homopolymers and copolymers, polypropylene homopolymers and copolymers, elastomers, and combinations thereof.

21. The film as claimed in claim 18, wherein the at least one additional polymer comprises very low density polyethylene.

22. The film as claimed in claim 6, wherein the particulate filler comprises an inorganic filler.

23. The film as claimed in claim 22, wherein the inorganic filler comprises calcium carbonate.

24. The film as claimed in claim 6, wherein the particulate filler comprises an organic filler.

25. The film as claimed in claim 6, stretch oriented at least biaxially to about 3×6 times the original area.

26. The film as claimed in claim 25, wherein the film is stretched to 18 times the original area.

27. The film as claimed in claim 6, stretch oriented at least biaxially to about 4×7 or 28 times the original area.

28. The film as claimed in claim 27, wherein the film is stretched 28 times the original area.

29. The film as claimed in claim 6, stretch oriented at least biaxially to about 5×8 the original area.

30. The film as claimed in claim 29, wherein the film is stretched to 40 times the original area.

31. A multilayered polypropylene film, comprising:
a voided core layer having a first surface and a second surface including polypropylene and particulate voiding agent;
a first non-voided outer layer including polypropylene adhered to the first surface of the core layer; and
a second non-voided outer layer including polypropylene adhered to the second surface of the core layer.

32. The film as claimed in claim 31, wherein the voided core layer includes about 40% and above by weight of calcium carbonate.

33. The film as claimed in claim 31, wherein the voided core layer includes about 0-5% by weight of titanium dioxide.

34. The film as claimed in claim 31, wherein the first non-voided outer layer is flame treated.

35. The film as claimed in claim 31, wherein the second non-voided outer layer is corona discharge treated.
